(19) United States
(12) Patent Application Publication
(10) Pub. No.: US 2004/0199398 A1
(43) Pub. Date: Oct. 7, 2004

(54) Device and method for transmitting information for each region

(76) Inventor: Tomoki Kubota, Tokyo (JP)

Correspondence Address: Lorusso Loud & Kelly, 3137 Mount Vernon Avenue, Alexandria, VA, 22305, US

(21) Appl. No.: 10/478,747

(22) PCT Filed: Jun. 3, 2002
(86) PCT No.: PCT/JP02/05425

(30) Foreign Application Priority Data
Jun. 7, 2001 (JP) 2001-172957

(51) Int. Cl. G06F 17/60

(52) U.S. Cl. 705/1; 705/10

(57) ABSTRACT

On a vehicle, a device for estimating a present position such as a GPS device and a communication device such as a cell phone are installed. The vehicle transmits a detected present position to an information center at specified intervals. On the other hand, the information center sets a plurality of areas in a region to which information is transmitted, and sets information for transmission for each area. When receiving data indicating the present position of the vehicle from the vehicle, the information center specifies, by using the data, an area where the vehicle is located, and transmits the information set for the area to the vehicle.

### TECHNICAL FIELD

This invention relates to a device for transmitting information for each region and a method for transmitting information for each region and, more particularly, to a device for transmitting information for each region and a method for transmitting information for each region which transmit information to a mobile terminal device.

### BACKGROUND ART

A variety of information processing terminals such as a personal computer, a PDA (personal digital assistant), a cell phone and the like become pervasive, and transmission to users thereof of information such as an advertisement is commonly carried out.

When transmitting information such as an advertisement, it is important for those who want to transmit information to transmit to a subject and in a method of a higher effect in transmitting information, and the same applies to a case in which an advertisement or the like is transmitted to a navigation device installed on a vehicle.

To provide an advertisement effectively to such a navigation device, an art described in the Japanese Patent Laid-open No. Hei 11-65434 is proposed.

In the above-mentioned art, a server device receives a present position of a certain vehicle or a new individual information on a user from a mobile terminal device installed on the vehicle wirelessly, and advertisement information and the like related to the present position of the vehicle is transmitted to an applicable mobile terminal device.

In the above system, the mobile terminal device obtains and transmits to the server device the present position of the vehicle by a navigation device or the like installed on the vehicle. The server device selects and transmits to an applicable mobile terminal device an advertisement of, for example, a restaurant a restaurant in the vicinity of the present position, or along a route connecting the present position and a destination, of which a user can take advantage immediately.

In this manner, an advertisement of, for example, a restaurant, a gas station, and the like along a route which a user takes can be transmitted to the user, so that a higher advertising effect is achieved.

However, with the art described in the above-referred publication, a person who transmits information such as an advertisement (a person who wants to transmit information) cannot specify a region to which the person wants to transmit the information.

Further, in the case of the art described in the above-referred publication, it is a problem for a person who wants to transmit information that a plurality of advertisements such as one by the person who wants to transmit information as well as ones by third parties are transmitted to a vehicle, which makes the advertising effect proportionately reduced. Moreover, a person who wants to transmit information cannot specify and purchase a region in which he/she wants to transmit an advertisement.

Accordingly, an object of the present invention is to provide an information transmission device for each region and an information transmission method for each region which provide a higher effect in information transmission for a person who wants to transmit information.

### DISCLOSURE OF THE INVENTION

In the present invention, the aforesaid object is attained by including in a device for information transmission for each region: a region specifying information obtaining means for each region to obtain region specifying information for specifying a region from a region purchaser who wants to purchase the region to which he/she transmits information; an information-for-transmission obtaining means to obtain information for transmission from the region purchaser from who the region specifying information is obtained; a storing means to store in a storage medium the obtained region specifying information and the obtained information for transmission by relating one to the other; a present position information obtaining means to obtain a present position information to specify a present position of a mobile terminal device; and a region determination means to determine in which of each region stored in the storage medium the obtained present position of the mobile terminal device is located; and a transmission means to transmit to the mobile terminal device, when the mobile terminal device is determined to be located in any of the regions, the information for transmission related to the region which is stored in the storage medium.

Further, the present invention includes a region fee amount calculating means to calculate a fee amount for a region specified by the obtained region specifying information, and a fee amount outputting means to output the calculated fee for the region.

Furthermore, in the present invention, the region fee amount calculating means calculates the fee based on at least one of the area size of the region, the number of signals present within the region, the availability of parking spaces within the region, the length of roads within the region, the density of the mobile terminal devices within the region, and a moved distance of the mobile terminal device passing through the region.

Further, in the present invention, a map transmission means is provided to transmit a map information to display a map which indicates regions available for sale according to a request by a region purchaser, to the region purchaser who made the request, and the region specifying information obtaining means mentioned above obtains the area specifying information specified by the region purchaser based on the transmitted map information.

In the present invention, the region specifying information obtaining means sells a non-overlapping region to a region purchaser by obtaining the region specifying information on a region which does not overlap the region specified in the region specifying information already stored in the storage medium.

In the present invention, the region specifying information obtaining means obtains, together with the region specifying information, an additional condition information to specify an additional condition consisting at least one of a season, a time frame, and a term so that a region in which both the region and the additional condition thereof do not overlap is sold to the region purchaser; and the storing means which stores the obtained region specifying information, the obtained transmission information, and the obtained additional condition information by relating these three information to each other in the storage medium; and the region determination means determines where the obtained present position of the mobile terminal device is located within any region stored in the storage medium which satisfies the additional condition related to each region.

Further, the present invention attains the aforementioned object by including: a region specifying information obtaining step in which the region specifying information obtaining means obtains a region specifying information to specify a region from the region purchaser who wants to purchase the region to which he/she transmits information; an information-for-transmission obtaining step in which the information-for-transmission obtaining means obtains information for transmission from the region purchaser who has obtained the region information; a storing step in which the storing means stores in the storage media the obtained region specifying information and the obtained information for transmission; a present position information obtaining step to obtain present position information to specify the present position of a mobile terminal device; a region determining step in which the region determiner determines where the obtained present position of the mobile terminal device is located within any of each region stored in the storage medium; and a transmitting step in which the transmission means transmits to an applicable mobile terminal device, when the mobile terminal device is determined to be located within any of the regions, the information for transmission stored in the storage media which is related to the region.

### BRIEF DESCRIPTION OF DRAWINGS

FIG. 1 is a diagram to explain an information transmitting system of a present embodiment.

FIG. 2 shows an example of a structure of a transmission server.

FIG. 3 shows an example of data stored in an area information database.

FIG. 4(A) shows an example of a structure of an area sales server, (B) shows an example of an area sales program, and (C) shows an example of a structure of a database.

FIG. 5 shows an example of a structure of a client terminal device.

FIG. 6 shows an example of a structure of a mobile terminal device installed on a vehicle.

FIG. 7 is a flowchart showing an area purchase (area sales) process performed between the advertiser terminal device and an information center.

FIG. 8 shows an example of an area setting screen.

FIG. 9 shows an example of a contents setting screen.

FIG. 10 is a flowchart to explain operations of the transmission server.

FIG. 11 is a flowchart to explain operations of the mobile terminal device.

FIG. 12 shows an example of a screen displayed on a display device.

FIG. 13 is a diagram to explain a modified example of the present embodiment.

### BEST MODE FOR CARRYING OUT THE INVENTION

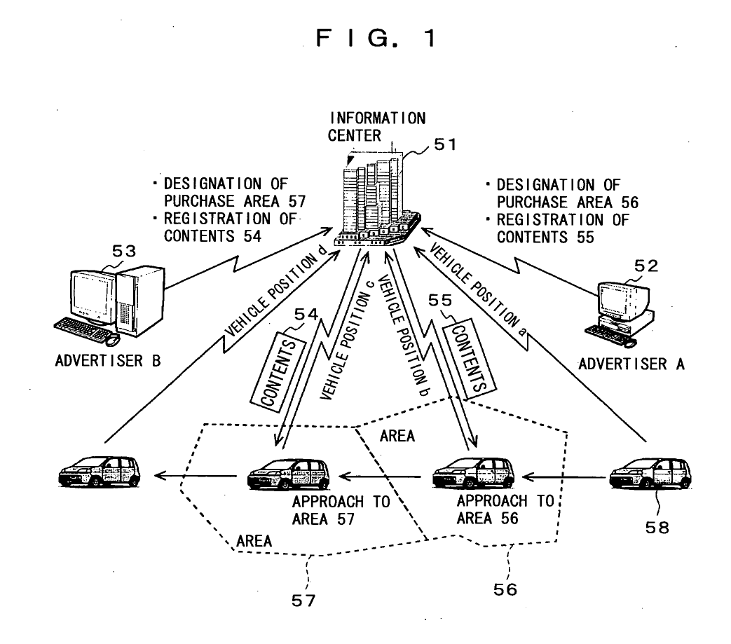

The preferred embodiment of the present invention will be hereinafter explained in detail with reference to FIGS. 1 to 13.

FIG. 1 is a system diagram showing an entire information transmission system.

In this information transmission system, information is transmitted between an information center 51, advertisers A and B, and a vehicle 58.

A device for transmitting information for each region in the information center 51 (hereinafter simply referred to as “information center 51”) sells, with the advertisers A, B, and the like as region purchasers, a virtual land (“region”) to which an information transmission right is granted. The virtual land regions are sold without overlapping one another.

For example, the advertiser A specifies a purchase area (“region”) 56 via a client terminal 52, purchases the region, and transmits to the information center 51 contents (information for transmission) 55 which is to be transmitted to a mobile terminal device present within the purchased area. The information center 51 stores in its database, together with purchaser data (an ID or the like), the region 56 and the contents 55 such as an advertisement which are received from the advertiser A.

In the meantime, a navigation device of the vehicle 58, which is the mobile terminal device, (hereinafter simply referred to as “vehicle 58”) detects at specified intervals (specified time intervals, specified running distances, specified event occurrences, or the like) the present position of the vehicle, and transmits the position to the information center 51. By obtaining the present positional information transmitted from the vehicle 58, the information center 51 determines whether the position is in any region of the regions stored in the database.

For example, when the vehicle 58 is not located in any of the regions but in a vehicle position such as “a” or “d”, the information center 51 does not transmit contents, since there are no corresponding contents. On the other hand, when judging the vehicle 58 to be located in the region 56, the information center 51 transmits to the vehicle 58 the contents 55 stored in the database as corresponding contents to the region 56. When the vehicle 58 moves from the region 56 to a region 57, the information center 51 determines, from the received vehicle position “c”, that the vehicle is located in the region 57, and transmits to the vehicle 58 contents 54 of the advertiser B which is correspondingly stored in the database.

As described above, the advertisers A and B attain a high effect in transmitting contents, since they are able to transmit exclusively their own contents to the mobile terminal devices within the regions they purchased.

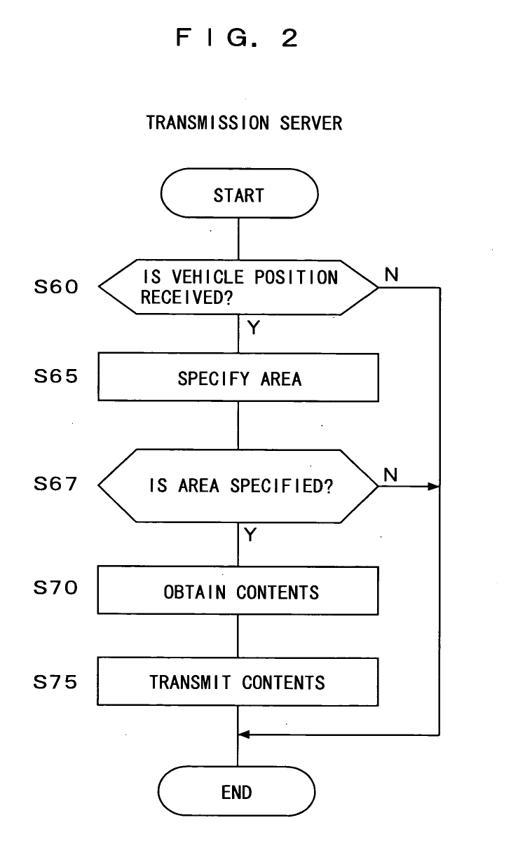

FIG. 2 shows a structure of the information center 51 in connection with the device for transmitting information for each region of the present embodiment.

As shown in FIG. 2, the information center 51 includes an area sales server 5, a transmission server 78, and an area information database 83.

The area sales server 5 is provided connectablly to advertiser terminal devices 7, 7, 7, . . . of the advertisers A, B . . . through an internet 8.

The area sales server 5 is a server device to perform a process to sell a virtual land the information transmitting right to which being granted to an advertiser 7 who is a region purchaser, as well as such storing processes as saving or updating area information corresponding to the sold region in the area information database 83. The area sales server 5 functions as a region specifying information obtaining means, an information-for-transmission obtaining means, a storing means, a region fee amount calculating means, a fee amount outputting means, and a map transmission means.

The area sales server 5 will be described later in further detail.

The transmission server 78 is a server device to obtain the present position information from the mobile terminal device such as a navigation device or the like which is installed on the vehicle 58, and to provide to an applicable vehicle the content data stored correspondingly to the area where the vehicle exists in the area information database. This transmission server 78 functions as a present position information obtaining means, a region determination means, and a transmission means.

The transmission server 78 is configured by a computer system having therein a CPU and a ROM which are not shown in the figure, as well as a second communication controlling section to control communication with the area sales server 5.

The transmission server 78 includes the communication controlling section 79, a vehicle position specifying section 80, and a contents obtaining section 84.

The communication controlling section 79 functions as a part of the present position information obtaining means and as a transmission means. The communication controlling section 79 transmits and receives data to and from the mobile terminal device installed on the vehicle 58 (hereinafter simply referred as “vehicle 58”). The communication controlling section 79 is provided so as to be connectable with the mobile terminal device through various methods such as a telephone circuit using a wireless network of a cell phone, satellite communications, and a communication via internet 8.

From the mobile terminal device 61 to the communication controlling section 79, the present position information indicating the present position of the vehicle 58 is transmitted, while from the communication controlling section 79 to the mobile terminal device 61, the content data such as advertisement information is transmitted.

The vehicle position specifying section 80, which functions as a part of the present position information obtaining means, obtains the present position information from the communication controlling section 79 and thereby specifies the present position of the vehicle 58.

It should be noted that the communication controlling section 79 and the vehicle position specifying section 80 functioning as the present position information obtaining means can be made such that, besides obtaining the present position information which is detected and transmitted by the mobile terminal device, they detect a specific electric wave outputted from the mobile terminal device, and the position is specified and obtained on the side of the transmission server 78. For example, the electric wave emitted from the vehicle 58 is received by a plurality of wireless base stations such as cell phone base stations, and depending on the intensity of the received electric wave, the region where the vehicle 58 is located is specified, and the specified region can be obtained as a position information. In that case, the specification of the region where the vehicle 58 is located also can be performed by a base station owned by the information center 51, or can be performed by an other agency from which the positional information may be obtained.

The contents obtaining section 84, which functions as the region determination means, receives from the vehicle position specifying section 80 the present position information on the vehicle 58, and determines in which area of each area stored in the area information data base 83 the vehicle 58 is located.

When the vehicle 58 is located in a sold area, the contents obtaining means 84 reads out the stored contents (information for transmission) corresponding to that area and supplies such contents to the communication controlling section 79.

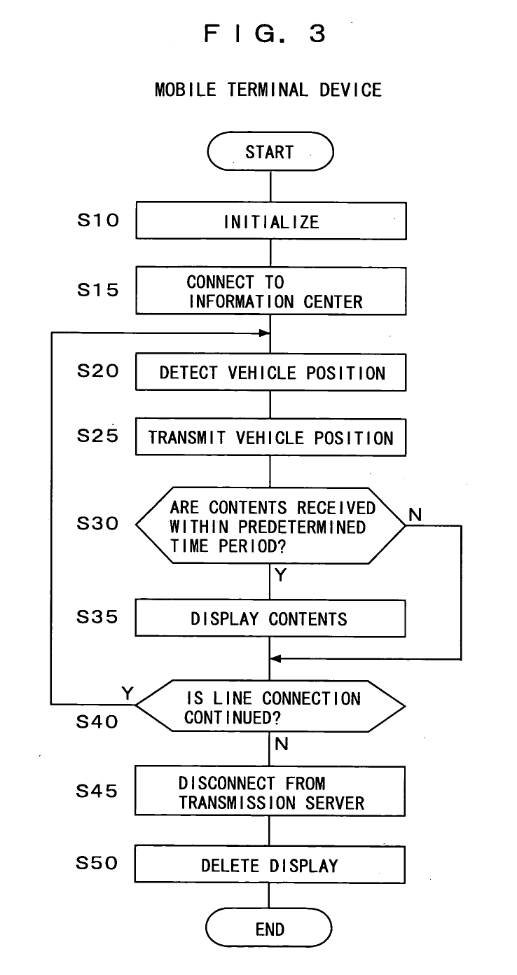

FIG. 3 conceptionally shows an example of contents of area information 97 stored in the area information database 83.

The area information 97 includes area number 90, area specification data 91, area size data 92, purchaser data 93, validity period data 94, content data 95, and other data 96. The area information 97 is prepared individually for each area sold to an advertiser.

The area number 90 is a number uniquely allocated to each area to specify the area. By designating this number, the area can be specified.

The area specification data 91 is data for specifying a zone of a region in which the area of interest is set. The area zoning is for the purpose of specifying the area which an advertiser purchased, and made by three or more absolute coordinate points (by longitude and latitude). The sold area is specified by a polygon each vertex of which is an absolute coordinate point.

It should be noted that the area specification data 91 can also be made, other than through absolute coordinate points, by coordinate points on a certain scale map as a standard map. In that case, the present position information of a mobile terminal device based on absolute coordinates needs to be recalculated into the coordinates for the aforesaid standard map, so that the area can be specified.

The purchaser data 93 is data on purchasers (advertisers A, B, . . . who specified and purchased the area) of the areas zoned by the area specification data 91. The area purchaser obtains the right to transmit contents to the mobile terminal device 61 present within the area. In the purchaser data 93, the data on the purchaser such as name, address, phone number, e-mail address, and billing address of the purchaser (advertiser) are stored.

The area size data 92 is data to indicate the area size of the area.

The validity period data 94 is data to indicate the period during which the purchaser specified by the purchaser data 93 is allowed to own the right of the area specified by the area specification data 91.

The content data 95 is content data (information for transmission) transmitted to a mobile terminal device 61 present within the area specified by the area specification data 91. The content data 95 is an advertisement data or the like provided as information to a driver, a passenger, and the like of the vehicle 58, and may include, for example, text data represented by characters, still image data, moving image data, voice data, and the like.

A document constituted by text data is an advertisement, an event introduction, a phone number, or the like. Depending on the content data 95, it is possible to transmit positional information (such as a map) or software to the mobile terminal device.

The content data 95 is received from the terminal devices 7 of the advertisers A, . . . who are the area purchasers, and stored in the area information 97.

The other data 96 include, for example, data to specify a borrower of the right to transmit the content data 95 to a certain area, in other words, to specify a right-of-use holder when the right of use on the relevant area is set, information to specify an area (hereinafter referred to as “sub-area”) within the relevant area for which the right of use is set, contents (hereinafter referred to as “sub-contents”) data of the right-of-use holder of the transmission right in a sub-area, and other data.

Next, the area sales server 5 and the advertiser terminal devices 7, 7, 7 . . . (FIG. 2) will be explained.

The area sales server 5 is connected to the internet 8. The area sales server 5 is a server device to provide services such as setting an area for a logged-in advertiser, setting content data to be transmitted to the set area, and the like.

The area server 5 stores various types of images such as a area setting screen or a contents setting screen to be presented to an advertiser through the advertiser terminal device 7.

These screen images are, for example, described by HTML (Hyper Text Markup Language).

The advertiser terminal devices 7, 7, 7 . . . are capable of communicating with the area server 5 through the internet 8.

The advertiser terminal devices 7, 7, 7 . . . are, for example, a personal computer (PC), a cell phone, a word processor equipped with a communication function, a modem-built-in digital television, and the like.

By connecting the adviser terminal devices 7, 7, 7 . . . to the area sales server 5, the advertiser sets a new area, changes the region of the area, or further sets and changes the contents to be transmitted within the area.

In each of the advertiser terminal devices 7, 7, 7, . . . , a browser is installed in advance, and such a browser is used to display the HTML screen data transmitted by the area sales server 5 on the display.

The advertiser can transmit area confirming information or content data to the area sales server 5 by inputting necessary information on the displayed screen.

The internet 8 consists of, for example, a telephone circuit, a cable television network, a satellite communication, and a fiber-optic network.

The advertiser terminal devices 7, 7, 7, . . . and the area sales server 5 communicate by using, for example, TCP/IP (Transmission control protocol/internet protocol).

It should be noted that although the advertiser terminal devices 7, 7, 7, . . . are directly connected to the internet 8 in FIG. 2, there are the cases where the advertiser terminal devices 7, 7, 7, . . . are connected to the internet 8 through an internet connecting agent called a provider.

Note that in the present embodiment, the advertiser terminal device 7 and the area sales server 5 are connected through the internet 8, but this is not a limited way, and the connection can be made by various communication means such as a dedicated circuit, LAN (Local Area Network), WAN (Wide Area Network), and the like.

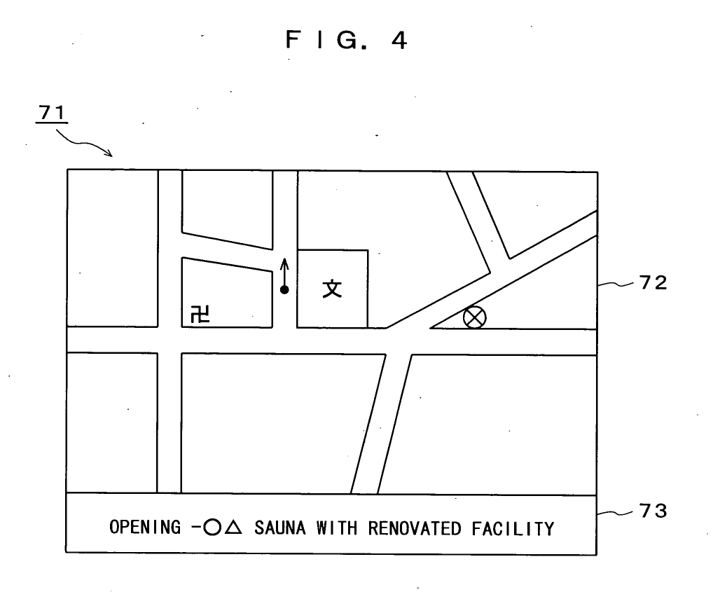

FIG. 4 shows examples of a structure of the area sales server 5 and contents of a hard disk.

As shown in the FIG. 4(A), the area sales server 5 is configured by a computer system having a high-speed and advanced information processing functions such as a workstation (such as a high-end personal computer).

A CPU (Central Processing Unit) 29 performs various processings, calculations, condition determinations, controls of devices such as displays, and the like, according to a program stored in a ROM (Read Only Memory) 30, a program loaded onto a RAM (Random Access Memory) 31, or the like.

The ROM 30 is a read-only memory which stores basic programs and parameters to realize each function of the area sales server 5.

The RAM 31 is a memory to store programs and data necessary for the CPU 29 to perform various types of processings, in which the CPU 29 can change the memory content.

An interface 32 is connected to various types of devices such as a hard disk 33, a magnetic optical disk 34, a communication section 35, an input section 36, a display 37, and a printing device 38, as well as the CPU 29 and the like, providing an interface between these devices and the CPU 29 and the like.

A bus line 28 is a transmission medium wherewith the interface 32 transmits and receives data, control signals, and the like to and from the CPU 29, the ROM 30, the RAM 31, or the like. The bus line 28 is also connected to the area information database 83, and the CPU 29 stores and updates in the area database 83 the area information obtained from the advertiser terminal device 7 through the bus line 28.

The magnetic optical disk 34 is used for backing up of programs and data since that the magnetic optical disk 34 is generally slower in access speed than the hard disk 33, and that it is attachable and detachable to and from the advertiser terminal device 7.

The communication section 35 is a device to transmit and receive information by connecting to the advertisement terminal device 7 through various types of communication means such as the internet 8.

The input section 36 consists of a keyboard, a mouse, and so forth. The keyboard is an inputting means to input character information and the like. The mouse is a pointing device to input data by left-clicking an icon or a button (key) presented on the display. Other than the mouse, a tablet, a touch-panel, a joystick, and the like may be used.

The display 37 is a display device consisting of, for example, a CRT (Cathode Ray Tube), a liquid crystal display, a plasma display, or the like.

The printing device 38 consists of a printer such as a laser printer, an inkjet printer, a dot printer, a page printer, a thermal printer, a thermal transfer type printer, or the like. The printing device 38 is used in such cases as outputting of an invoice indicating the area sales price for a purchaser of the area.

The hard disk 33 has a storage medium which is accessible by the CPU at high speed and has a large capacity, in which various programs and data are stored. The hard disk 33 stores, for example, the area sales program 39, the database 40, and other types of programs and data.

The area sales program 39 is a program to realize various functions to update the area information 97 in the area sales server 5. Note that each of such program for realizing the present embodiment may be stored in, other than the hard disk 33, various storage media which will be described later.

FIG. 4(B) is a diagram showing an example of a structure of the area sales program 39. The area sales program 39 is composed of an area setting module 41, an analysis module 42, a contents setting module 43, an area information update module 44, a fee processing module, and the like.

The area setting module 41 is a module (component) functioning as a region specifying information obtaining means and a map transmission means, whereby an area desired to be purchased can be specified by the advertiser terminal device 7.

The area setting module 41 transmits to the advertiser terminal device 7 data to display the area setting screen. As will be explained later, the advertiser can input an area desired to be purchased, by circling, with a mouse, the desired region on the map displayed on the area setting screen. By purchasing the area, the advertiser obtains the right to exclusively transmit content data to the mobile terminal devices present in that area.

The analysis module 42 is a module to perform various calculations. For example, when the advertiser sets an area on the area setting screen, the analysis module 42 calculates the area size of that area, or the vehicle traffic volume of the area by using a statistical data.

The analysis module 42 also functions as a region fee amount calculator and an invoice creator, as well as, by working together with the printing device and the communication section, a fee amount outputting means. The analysis module 42 calculates the sales price of the area which is set by the advertiser, and creates an invoice based on the calculated amount.

The contents setting module 43 functions as a transmission information obtaining means, and is a module with which the contents such as advertisement contents to be transmitted to the mobile terminal devices 61 present in the area set by the area setting module 41 can be inputted by the advertiser terminal device 7.

The contents setting module 43 transmits data for displaying the contents setting screen to the advertiser terminal device 7. The advertiser can input text data, image data, voice data and the like on the contents setting screen. The data inputted by the advertiser are transmitted from the information center 51 to the mobile terminal devices 61 present in the area for which the advertiser owns the transmission right.

The area information updating module 44 is a module to save in the area information database 83 the area information inputted by an advertiser through the area setting screen or the contents setting screen, and to update the stored area information based on an updating information from the advertiser terminal device 7.

FIG. 4(C) shows an example of a structure of the database 40.

The database 40 stores map data 45, statistical data 46, sales price data 47, and the like.

The map data 45 is used to transmit a map of an area requested by the advertiser terminal device 7 when the area setting module 41 is functioning as a map transmission means.

Specifically, when the area server 5 transmits the area setting screen to the advertiser terminal device 7, the area setting module 41 obtains the map data 45, which is transmitted from the communication section 35 to the advertiser terminal device 7.

The statistical data 46 stores, for example, various types of statistical data such as a moved distance of each mobile terminal measured at each point of the map. These data are used, for example, when the analysis module 42 calculates the traffic of vehicles in an area to be set by the advertiser.

The sales price data 47 stores basic data to calculate, when the advertiser sets a purchasing area, the sales price of that area. Those appropriate as the basic data for the sales price calculation are such data as unit price per area, unit price per signal, unit price of parking space per area, unit price per length of road, unit price per moved distance, unit price per mobile terminal device density, and the like.

When a user sets a zone of an area to purchase, the analysis module 42 calculates the sales price of that area by using the sales price data 47.

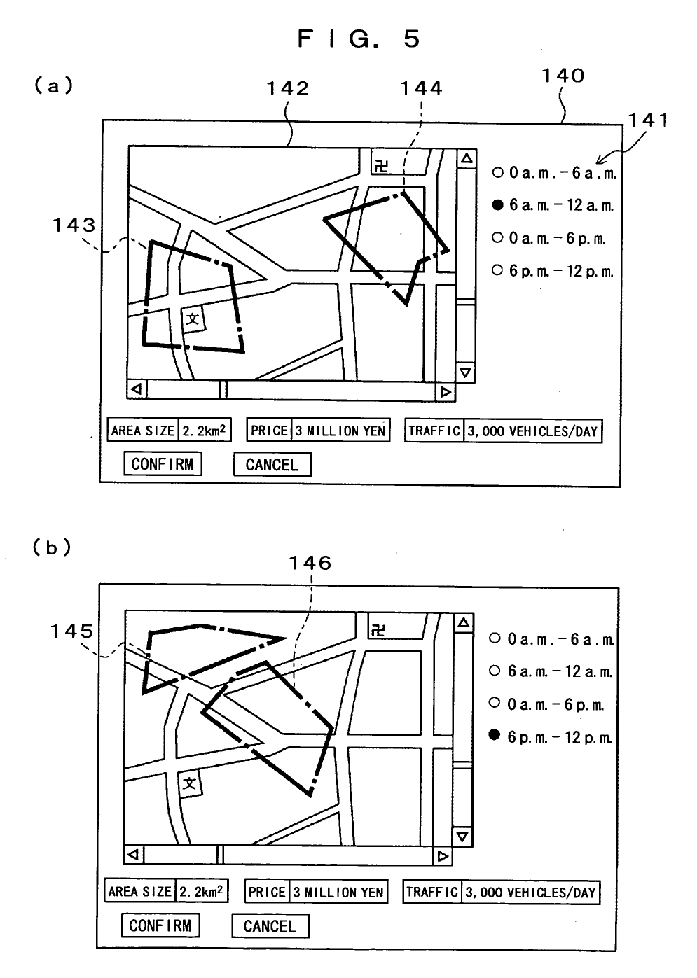

FIG. 5 shows an example of a structure of the advertiser terminal devices 7, 7, 7, . . . .

For the present embodiment, an example is given in which the advertiser terminal device 7 is constituted by a personal computer (PC), although the advertiser terminal device 7 may also be constituted by a terminal having similar functions to the personal computer.

Hereinafter, an explanation is given by citing one device among a plurality of the advertiser terminal devices 7, 7, 7, . . . .

The basic structure of the advertiser terminal device 7 is similar to that of the area sale server 5.

A CPU 11 performs various processings, calculations, condition determinations, and controls of each device such as a display, according to a program stored in a ROM 12 or a program loaded onto a RAM 13.

The ROM 12 is a read-only memory which stores basic programs and parameters for the advertiser terminal device 7 to operate.

The RAM 13 is a memory to store programs or data required by the CPU 11 to perform various types of processings, and the CPU 11 can change the stored content.

An interface 15 is connected to various devices such as a hard disk 16, a magnetic optical disk 17, a communication section 18, an input section 19, a display 20, and a printing device 15, as well as to the CPU 11 and the like, providing an interface between these devices and the CPU 11 and the like.

A bus line 14 is a transmission medium wherewith the interface 15 transmits and receives data, control signals, and the like to and from the CPU 11, the ROM 12, and the RAM 13 and so forth.

The hard disk 16 is provided with a storage medium which is accessible at high speed and having a large capacity to store various programs and data.

The hard disk 16 stores, for example, a browser 21, a line connection program 22, other programs 23, and various types of databases 24.

The browser 21 is a program to display HTML files on the display 20. The browser 21 allows the display 20 to display thereon the area setting screen or the contents setting screen transmitted by the area sales server 5.

The HTML file is a file which describes a document structure, a location of an image, a link destination, and the like by using a tag (a kind of a reserved word) or the like. With the HTML file, for example, each screen such as the area setting screen can be defined. By using the browser, the screen defined by the HTML file is displayed on the display or the like.

The line connection program 22 is a program to connect the advertiser terminal device 7 to the internet 8 (or to a provider if the advertiser terminal device 7 is connected to the internet 8 through the provider).

The magnetic optical disk 17 is used to back up programs and data since it is generally slower in access speed than the hard disk 16, and is attachable and detachable to and from the advertiser terminal device 7.

The communication section 18 is a device to connect the advertisement terminal device 7 to the internet 8. The communication section 18 is constituted by a modem or the like when the advertiser terminal device 7 is connected to a public circuit.

The input section 19 includes a keyboard, a mouse, and the like. The keyboard is an inputting means to input character information and the like, and used when inputting characters onto the area setting screen, the contents setting screen or the like displayed through the HTML file received from the area sales server 5.

The mouse is a pointing device to input data by left-clicking it at an icon or a button presented on the display. Other than the mouse, a tablet, a touch-panel, a joystick, or the like may be used.

The display 20 is a display device constituted by, for example, a CRT (Cathode Ray Tube), a liquid crystal display, a plasma display, or the like.

The display 20 displays each type of screen such as the area setting screen or the contents setting screen received from the area sales server 5, and displays a result of input by the advertiser using a keyboard or the like.

The printing device 25 is constituted by, for example, a printer such as a laser printer, an inkjet printer, a dot printer, a page printer, a thermal printer, a thermal transfer type printer, or the like. The printing device 25 is used when printing displayed contents (including inputted contents) on the area setting screen or the contents setting screen, and other types of displayed contents, for example.

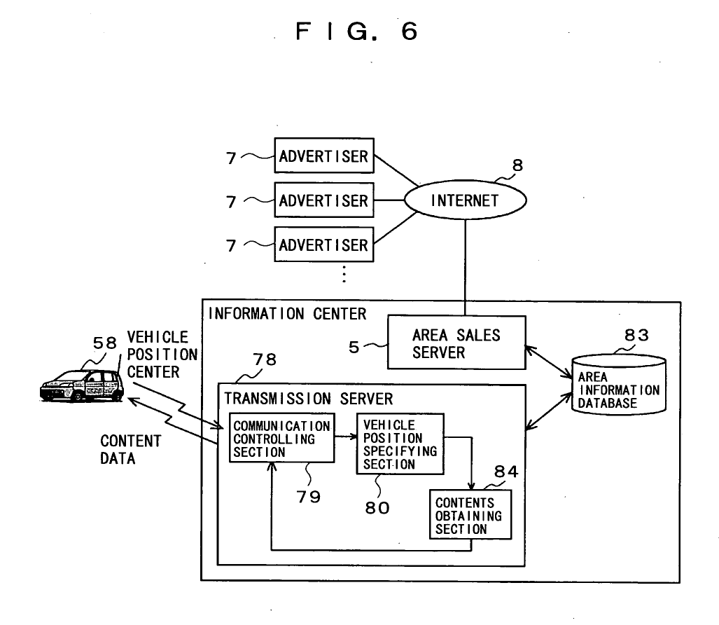

FIG. 6 shows an example of a structure of the mobile terminal device 61 which is installed on the vehicle 58.

As shown in FIG. 6, the mobile terminal device 61 of the present embodiment includes a GPS device 62, a vehicle information sensor 66, a navigation device 65, a communication device 64, a display device 67, and the like.

The GPS device 62 is equipped with an antenna not shown, and receives an electric wave transmitted by a plurality of artificial satellites (GPS satellites) going around thereover. The GPS device 62 calculates the present position by analyzing information included in the electric wave received from the plural GPS satellites.

The vehicle information sensor 66 is a unit to detect a driving state of a vehicle and is composed of various types of sensors such as a vehicle speed sensor, a brake sensor, a distance sensor, and a steering sensor. The data detected by these sensors are used for calculating the present position of the vehicle 58, for example. The GPS device 62 may not be able to properly receive a signal from a GPS satellite, when, for example, it is located between tall buildings or in a tunnel. Even when the GPS device 62 does not operate properly, the navigation device 65 is capable of defining the present position of the vehicle by using data detected by the vehicle information sensor 66.

The communication device 64 is constituted by a wireless radio. Besides the wireless radio, the communication device 64 may be constituted by a cell phone, a DRGS (Dynamic Route Guidance System), a beacon (radio beacon or optical beacon) or the like.

It should be noted that the DRGS is a dynamic route guidance system to select and guide a optimal route in light of a traffic information by VICS (Vehicle Information and Communication System) which provides a real-time traffic information to the navigation device or the like in the vehicle through the (radio/optical) beacons set by a roadside and a FM multimedia broadcasting service.

The beacon is a radio apparatus set over a road, and when a vehicle passes thereunder, information is exchanged.

The communication device 64 is equipped with an antenna 63, and obtains the present positional information from the navigation device 65 and sends it wirelessly to the information center 51, while receiving content data and the like transmitted from the information center 51.

The navigation device 65 has a microcomputer not shown (hereinafter referred to as a micon) and a ROM. Based on the programs stored in the ROM, the micon controls the GPS device 62, the vehicle information sensor 66, the communication device 64, and the display device 67, and performs various conversions such as a calculation of the present position.

The navigation device 65 has a running device to run storage media such as a CD-ROM (Compact Disk-ROM), so as to obtain map data stored in the storage media by using the running device.

The navigation device 65 calculates the absolute coordinate of the present position (by longitude and latitude) based on the information obtained from the GPS device 62 and the vehicle information sensor 66, which is supplied to the communication device 64 as a present positional information. The navigation device 65 also creates presentation data to present an icon indicating the present position of a vehicle overlappingly on the map presented on the display device.

Further, the navigation device 65 includes, when creating the presentation data, in that presentation data the content data received from the information center 51 through the communication device 64.

The display device 67 is a display device such as a liquid display or a plasma display capable of displaying an image.

The display device 67 displays a predetermined screen based on the presentation data created by the navigation device 65.

The screen is structured, for example, such that the upper part thereof is a screen for a location function to inform the present position or a screen for a route guide to the destination, and the lower part thereof is a screen to display contents such as an advertisement received from the information center 51.

Additionally, the display device 67 is provided with a switch to specify display/non-display of an advertisement screen, wherewith the contents display screen is displayed or not displayed by manipulations by the user of the mobile terminal device 61.

In the present embodiment, the mobile terminal device 61 may be further equipped with a reception selecting means to select to receive or not to receive the contents (information for transmission) transmitted from the information center 51.

The mobile terminal device 61 is equipped with a voice outputting means not shown, and reproduces the voice data and outputs the voice contents when content data received from the information center 51 includes voice data. Additionally, a speaker which functions as a part of a voice outputting means to output voice contents may be a speaker dedicated to the mobile terminal device 61, or, if the mobile terminal device 61 is a vehicle, a speaker already installed on that vehicle may be used, or, if the mobile terminal device is a cell phone, a speaker installed on that cell phone may be used.

In the following, each operation of the information transmission system structured as described above will be explained.

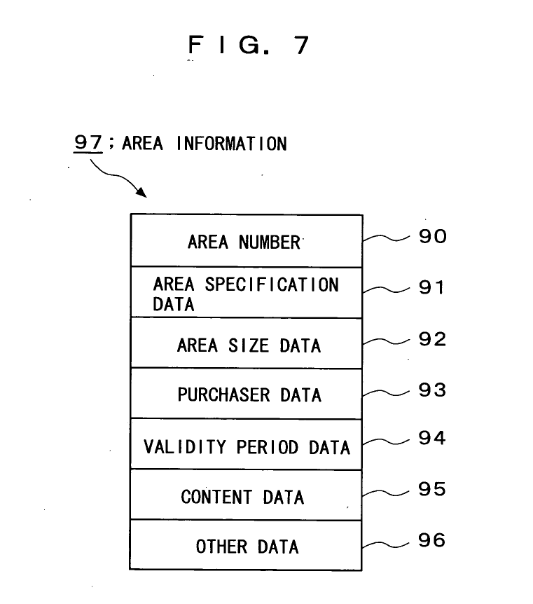

FIG. 7 is a flowchart showing an area purchasing (area selling) process between the advertiser terminal device 7 and the information center 51.

Based on a manipulation by an advertiser, the advertiser terminal device 7 accesses the area sales server 5 in the information center 51 through the internet 8 (step 100).

Accessed by the advertiser terminal device 7, the area sales server 5 transmits a top page to the advertiser terminal device 7 (step 200). In the top page to be transmitted are items to select or input a region desired to be purchased such as a column to input a zip code, a column to input an address and phone number within the region desired to be purchased, and columns to select a name of a place such as prefecture, city, ward, town, village. The phone number to be inputted is either an area code or an area code plus a local code. The regional name is selected from the names listed in a pull-down menu. For each category, any one item can be inputted or selected.

When receiving the top page, the advertiser terminal device 7 displays it on the display 20. It is displayed on the display 20 according to the browser (software) 21 by using the received data (the same applies to the following procedures).

When an area desired to be purchased is specified by an advertiser through each column of the top page presented, the advertiser terminal device 7 transmits to the area sales server 5 the desired area which was specified (step 102).

The area sales server 5 reads out of the map data 45 a map of a predetermined range which includes the specified area according to the area setting module 41 of the area sales program 39, creates an area setting screen, and transmits it to the advertiser terminal device 7 (step 202).

When receiving the area setting screen, the advertiser terminal device 7 it on the display 20 (step 104).

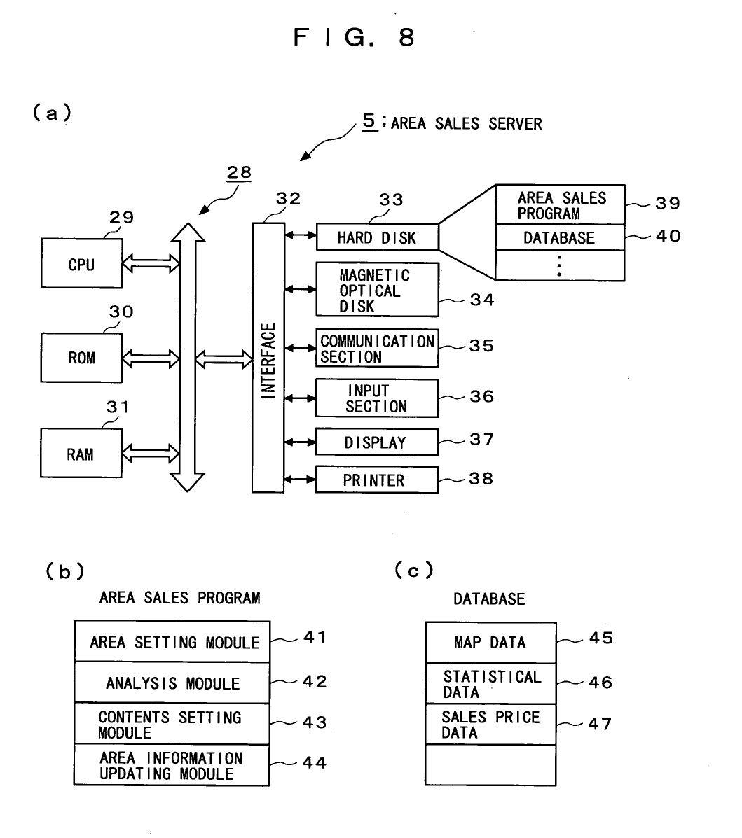

FIG. 8 shows a displaying example of an area setting screen 100.

As shown in FIG. 8, in the area setting screen 100, a map screen 103 is arranged, showing a map which includes the specified area.

On the map screen 103, sold areas 104, 105, . . . which are already sold and cannot be purchased are circled by a bold line. These sold areas are displayed by overlapping themselves on the displayed map by obtaining by the area setting module 41 the area specification data 91 of the sold area from the area information database 83 (see FIG. 3).

On the map screen 103, a vertical scroll bar 106 is arranged on its right side and a horizontal scroll bar 107 is arranged on its lower side, where the map screen can be scrolled up and down, or right and left by using both scroll bars.

On the lower side of the map screen 103, an area size column 108 displaying the area size of the area set by the advertiser, a price column 109 displaying the sales price of the set area, and a traffic column 110 displaying the number of the mobile terminal devices passing through the set area are arranged. The area size column 108, the price column 109, and the traffic column 110 are blank when an area setting screen is initially transmitted from the area sales server 5 (step 202).

At the bottom of the area setting screen 100, a confirmation key 101 to confirm the set area and a cancel key 102 to reset an area are arranged.

Note that the area setting screen 100 may be provided with a validity period column to enter the validity period for the area ownership (area ownership period), where the advertiser may enter a validity period data such as “one year” to limit the period for possessing the area right. In such a case, the area sales price shown in the price column 109 varies according also to the period.

The advertiser manipulates the both scroll bars 106 and 107 on the area setting screen 100, to display the area desired to be purchased on the map screen 103. The advertiser then sets the area by specifying a range which does not overlap the sold areas 104 and 105. Specifically, a polygon is drawn on the map by shifting a pointer 112 with a mouse, in which a left-clicked point becomes a vertex. This polygon may be presented by a dotted line for example, and the set area 111 inwalled by the dotted line represents the area desired to be purchased.

When the set area 111 is specified by the advertiser using the mouse and the confirmation key 101 is selected, the advertiser terminal device 7 transmits to the area sales server 5 the data corresponding to each vertex forming the set area 111 (the coordinate values on the map) as the area data (step 106).

On receiving the area data, according to the analysis module 42 the area sales server 5 converts the received area data into an area specification data formed by absolute coordinates (by longitude and latitude) based on the reduction ratio and the presented range of the map which is displayed on the area setting screen 100 transmitted in the step 202, and temporarily stores the data in the RAM 31.

The area server 5 then calculates, according to the analysis module 42, the area size of the area specified by the area specification data, and at the same time, calculates the traffic by referring to the statistical data 46 of the database 40, and calculates the area sales price by referring to the calculated traffic and the sales price data 47. The sales price is calculated based on at least one of the area size, the number of signals present in the area, the availability and the area size of the parking space(s) in the area, the road length in the area, the density of the mobile terminal devices within the area, and the moved distance of the mobile terminal device passing through the area.

The area sales server 5 transmits the calculated area size, price, and traffic to the advertiser terminal device 7 which is recognized by using the cookie or the OPS (open profiling standard) (step 204).

On receiving the area size, price, and traffic of the area specified by the advertiser, the advertiser terminal device 7 displays them, according to the browser 21, on the area size column 108, the price column 109, and the traffic column 110 on the area setting screen already displayed.

The greater the number of vehicles displayed in the traffic column 110, the greater the number of vehicles which receive the contents provided by the advertiser, so that the information in the advertisement pillar can be effectively transmitted.

The advertiser evaluates the displayed price, traffic, and the like, and selects the cancel key 102 when it is determined that an area change is necessary, or selects the confirmation key 101 when the set area is satisfactory.

When the cancel key 102 is selected (step 108; Y), the advertiser terminal device 7 clears the dotted representation of the specified area 111 displayed on the map screen 103, as well as the area size column 108, the price column 109, and the traffic column 110 (step 110), and returns to the step 106 to redesignate the area for purchase (transmit the area data).

On the other hand, when the confirmation key 101 is selected (step 108; N), the advertiser terminal device 7 notifies that the area data transmitted in the step 106 is confirmed (step 112).

On receiving the notification of the area confirmation, the area sales server 5 creates a contents setting screen to input contents such as advertisement contents according to the contents setting module 43, and transmits such contents setting screen to the advertiser terminal device 7 (step 206).

On receiving the contents setting screen, the advertiser terminal device 7 displays the contents setting screen on the display 20 (step 114). When the contents setting screen is displayed, it may be displayed on the display 20 either by deleting the area setting screen which is already displayed, or by opening another window overlappingly.

Note that while the present embodiment explains a case where the contents setting screen is transmitted and displayed on the display 20 after the area specified through the area setting screen 100 is confirmed, the order for display, input and setting may be reversed, or the input and the like can be performed concurrently on the both screen.

Further, it is possible to request and display the other screen when one screen is yet to be confirmed, and the confirmation is separately performed for each screen.

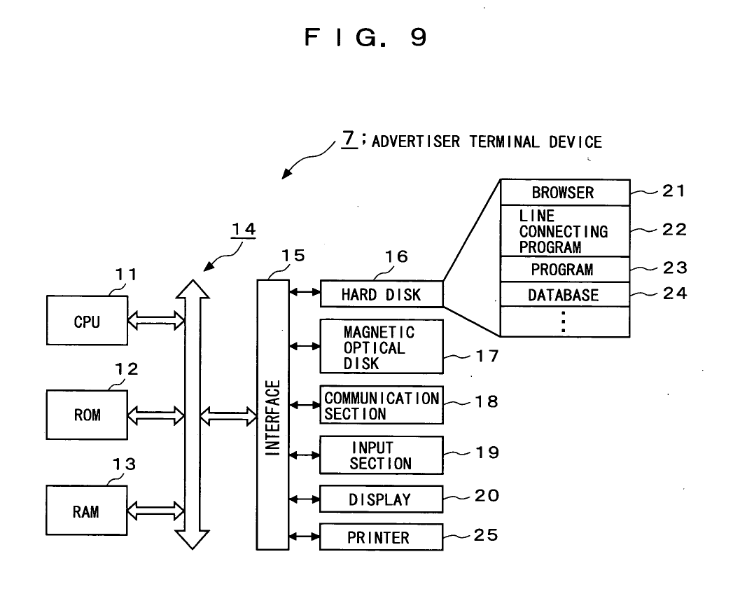

FIG. 9 shows an example of a contents setting screen 115.

The contents setting screen 115 is a screen for setting content data which is to be transmitted to the mobile terminal device 61 present in the set area 111 set by the advertiser though the area setting screen 100.

In the contents setting screen 115, a setting screen 128 is arranged on the upper part, while a test screen 129 is arranged on the lower part, as an example is shown in FIG. 9.

The setting screen 128 includes a text key 116, an image key 117, a voice key 118, an input column 119, a voice file display column 123, and so forth.

The text key 116 is used to input text data in the input column 119.

When the text key 116 is left-clicked, a text input column 120 appears on the input column 119. The size or the position of the text input column 120 can be modified by using a mouse.

By left-clicking the inside of the text input column 120 with the mouse, a cursor appears within the text input column 120. The advertiser can enter characters onto the position of the cursor by typing characters into a keyboard.

The image key 117 is used to input an image data in the input column 119. The image data to be inputted to the input column 119 should be prepared in advance.

By left-clicking the image key 117, an image data input column 121 is presented on the input column 119. By right-clicking the image data input column 121, a list box not shown in the figure appears. The list box presents a list of files or folders stored in various storage media such as the magnetic optical disk 17, the hard disk 16 and the like which are connected to the advertiser terminal device 7.

The advertiser can set image data in the image data input column 121 by left-clicking the image data displayed in the list box. When the image data is set in the image data input column 121, the corresponding image is displayed in the image data input column 121.

The voice key 118 is used to set voice data when such voice data is transmitted to the mobile terminal device 61.

The voice data should be created in advance and stored as a file. When the advertiser left-clicks the voice key 118, a list box appears which is not shown in the figure.

The applicable voice data can be set by left-clicking such voice data in the list of files or folders displayed on the list box.

The selected voice data is displayed in the voice file display column 123.

The test screen 129 is a screen for the advertiser to confirm how an item set through the setting screen 128 is displayed by the display device 67 in the mobile terminal device 61.

In the test screen 129 are arranged a dummy screen 130 to display a tentative map, and a test advertisement column 124 to display data inputted into the input column 119 in the setting screen 128.

The dummy screen 130 and the test advertisement column 124 in the text screen 129 are blank when the contents setting screen is transmitted from the area sales server 5 for the first time (step 206).

At the bottom of the contents setting screen 115, are arranged a test key 125 to test-display the contents on the dummy screen 130 and in the test advertisement column 124, a confirmation key 126 to confirm the contents, and a cancel key 127 to reset the contents.

By manipulating the setting screen of the contents setting screen 115, the advertiser sets contents such as the text, image, voice and the like (step 116).

Further, the advertiser selects the test key 125 to see the test screen of the set contents, the cancel key 127 to reset, and the confirmation key 126 to the set contents are satisfactory.

When the test key 125 is selected, the advertiser terminal device 7 transmits to the area sales server 5 the contents set through the setting screen 128 (step 118; Y).

By using the received contents, the area sales server 5 transmits the tentative map to be displayed on the dummy screen 130 and the test screen consisting of the contents to be displayed in the test advertisement column 124 (step 208). When voice data is included in the contents, such voice data is also transmitted. The area sales server 5 then relates the received contents to the area specification data converted in the step 204, and temporarily stores them in the RAM 31.

According to the received data, the advertiser terminal device 7 displays the image on the test screen 129 in the contents setting screen 115 which is already displayed (step 120).

It should be noted that in the present embodiment, the contents are transmitted to the area sales server 5 and the test screen is returned by the area sales server 5 when the test key 125 is selected, but it is also possible to provide a contents setting screen which allows the advertiser terminal device 7 to automatically create a test screen.

In other words, the contents setting screen 115 may be created by the contents setting module 43 of the area sales server 5 such that when the test key 125 is selected, the advertiser terminal device 7 displays the tentative map on the dummy screen 130 according to the browser 21 of the advertiser terminal device 7 and displays in the test advertisement column 124 the contents inputted in the input column 119, and that when voice data is included in the contents, the voice is outputted.

When the cancel key 127 is selected (step 122; Y), the advertiser terminal device 7 clears the contents set on the setting screen 128 (step 124), and returns to step 116 to set the contents again.

On the other hand, when the confirmation key 126 is selected (step 122; N) the advertiser terminal device 7 notifies that the contents transmitted in step 118 are confirmed (step 126).

On receiving the notification that the contents are confirmed, according to the area information updating module 44 the area sales server 5 reads out of the RAM 31 the area specification data and contents that have been temporarily stored, sets the area owner ID and the area number, and registers them as the area information 97 (refer to FIG. 3) in the area information database 83 together with the data such as the area size and the like calculated in step 204 (step 210).

Note that among the area information 97, the purchaser data 93 is inputted by the advertiser either through the top page that appears when accessing the information center 51, through the area setting screen 100, through the contents setting screen 115, or on a separate purchaser data inputting screen, and transmitted to the area sales server 5 to be received and stored.

Subsequently, the area sales server 5 charges the advertiser with the area sales fee based on the amount calculated in step 204 (step 212). It should be noted that the area sales fee may be charged in a manner that the purchased area is displayed on the map, and the invoice listing the details such as the area size, the amount charged, the payment method, the account to be credited and the like is transmitted to the advertiser terminal device 7 via e-mail (an amount outputting means), or that the invoice is printed out by the printing device 38 (an amount outputting means) and sent by mail to the advertiser.

According to the amount charged, the advertiser pays the fee to the information center 51 (step 128).

Next, operations to transmit contents from the information center 51 to the mobile terminal device will be explained.

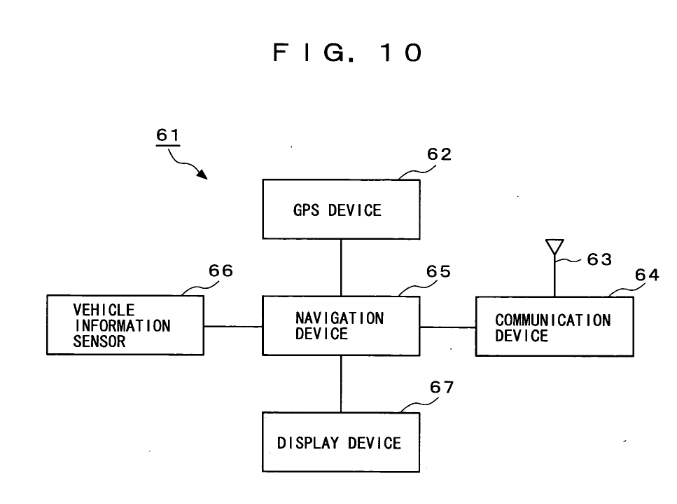

FIG. 10 is a flowchart to explain the operations of the transmission server 78.

The transmission server 78 operates full-time to constantly monitor whether the present positional information is being transmitted or not from the mobile terminal device 61 (step 60).

On receiving the present position from the mobile terminal device 61 (step 60; Y), the vehicle position specifying section 80 of the transmission server 78 analyzes the present positional information and specifies the present position of the mobile terminal device 61.

Then, the contents obtaining section 84 determines whether or not the mobile terminal device 61 is located in any of the sold area by using the area information database 83, and defines the located area (step 65).

When the contents obtaining section 84 fails to specify the area in which the mobile terminal device 61 is located, in other words, when the mobile terminal device 61 is not located in any of the areas in a step 67 (step 67; N), the contents transmitting operation is terminated, and the mode is shifted back to the present positional information monitoring.

On the other hand, when the contents obtaining section 84 was able to specify an area where the mobile terminal device 61 is located (step 67; Y), the contents obtaining section 84 obtains from the area information database 83 the content data corresponding to that area (step 70).

The transmission server 78 transmits the content data obtained in the contents obtaining section 84 to the mobile terminal device 61 via the communication controlling section 79 (step 75), and completes the process.

Note that if the mobile terminal device 61 is composed of a navigation system, a structure is possible in which data for navigation such as map data, route guidance data and the like may be transmitted together with the content data.

In the navigation system, there is a type in which a CD-ROM is provided in the vehicle to store the map data used for navigation, and another type in which the map data transmitted from the information center 51 and the like is obtained by the navigation device and used for navigation.

In the latter type, the mobile terminal device is connected to the navigation device, and the vehicle transmits the present positional information to the information center 51, while the information center 51 transmits to the vehicle the map data of the vicinity where the vehicle is driving.

The information center 51 can transmit the content data together with the data for navigation such as a map data, a route guidance data, and the like to the vehicle using the latter-type navigation system.

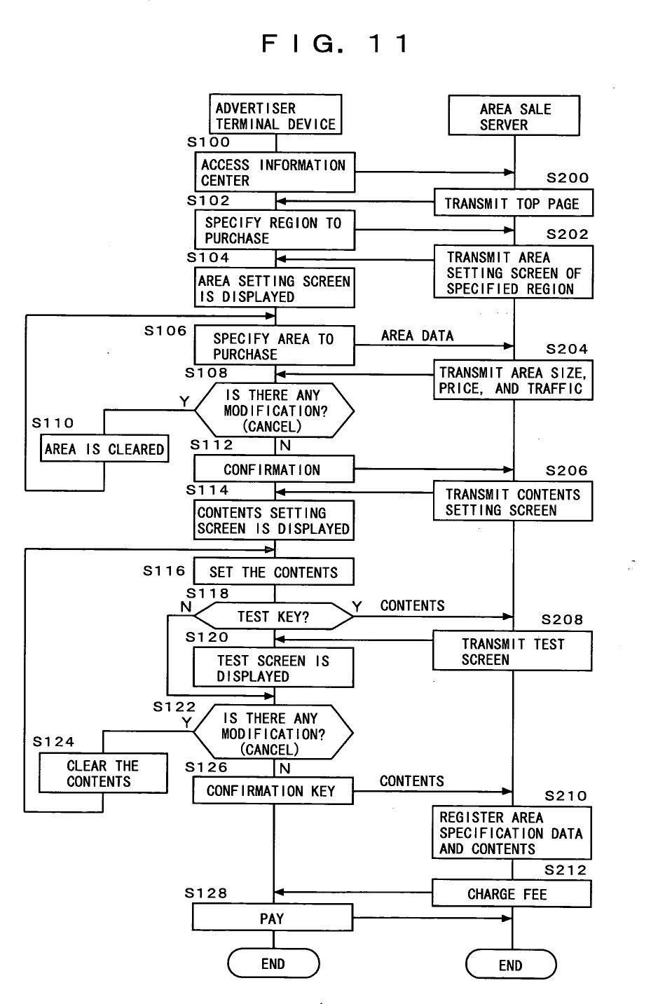

FIG. 11 is a flowchart to explain operations of the mobile terminal device 61.

When a user of the mobile terminal device 61 such as a driver of the vehicle 58 turns on a power switch of the vehicle terminal device 61, the vehicle terminal device 61 performs initialization (S10). This is an operation in which an initialization program stored in the ROM equipped in the navigation device 65 starts up, and the navigation device 65 initializes the GPS device 62, the communication device 64, the vehicle information sensor 66, and the display device 67.

Incidentally, the navigation device 65 is provided with a CPU, and controls the entire operations of the mobile terminal device 61 based on various programs stored in the ROM.

Next, the navigation device 65 connects the communication device 64 with the information center 51 wirelessly (step 15). The navigation device 65 then detects the present position using the present position obtained by the GPS device 62, and the vehicle speed, the brake state, and the like obtained by the vehicle information sensor 66 (step 20).

Next, the navigation device 65 provides the present position information to indicate the detected present position to the communication device 64.

The communication device 64 transmits the present position information on the vehicle detected by the navigation device 65 to the transmission server 78 in the information center 51 (step 25).

Subsequently, after transmitting the present positional information, the communication device 64 stands by for a predetermined time (20 seconds, for example) until the content data is transmitted from the transmission server 78 (step 30).

On receiving the content data such as advertisement contents from the transmission server 78 via the communication device 64 within the predetermined time (step 30; Y), the navigation device 65 displays the received content data on the display device 67 (step 35).

The information presented on the display device 67 is a text, still image, dynamic image and the like set by an advertiser. When the advertiser includes voice data in the content data, the navigation device 65 reproduces the voice data using speakers installed on the vehicle.

When the communication device 64 does not receive the content data from the transmission server 78 within the predetermined time (step 30; N), or after the display device 67 displays the contents, the navigation device 65 confirms whether the connection to the transmission server 78 should be continued or not (step 40). Here, the navigation device 65 checks the state of a connecting switch which is provided in the mobile terminal device 61 to connect or disconnect the communication line to the transmission server 78, because a user uses the switch at his/her option to connect or disconnect the communication line to the transmission server device 78.

Incidentally, the default (initial state) of the connecting switch is a state of connecting to the communication line to the transmission server 78, where the connecting switch automatically turns on when the user turns on the power switch of the mobile terminal device 61.

When the connecting switch is ON, the navigation device 65 returns to the step 20, and detects the present position of the vehicle.

When the connecting switch is OFF, the navigation device 65 disconnects the radio communication circuit with the server 78 (step 45).

Subsequently, the navigation device 65 deletes the contents screen which is displayed on the display device 67 by using the content data (step 50).

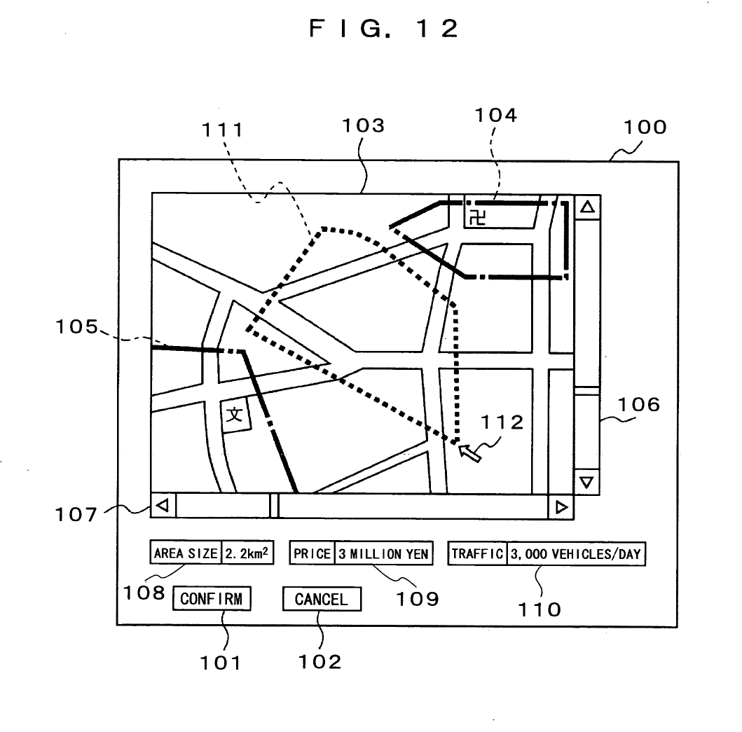

FIG. 12 shows an example of a screen 71 displayed on the display device 67.

The screen 71 has a navigation section 72 on the upper part thereof and a contents section 73 on the bottom part thereof.

The navigation section 72 displays a map of the vicinity where the vehicle 58 is driving, the present position of the vehicle 58, and the like. The present position of the vehicle 58 is calculated by the navigation device 65 by data obtained from the GPS device 62 and the vehicle information sensor 66.

The displayed contents in the contents section 73 are composed of content data transmitted from the information center 51.

In the example of the figure, an advertisement such as “Opening—◯Δ Sauna with the renovated facility” which is related to the area where the present position of the vehicle 58 is located is transmitted.

This advertisement is provided, for example, by the right owner for that area or by a person who obtained the right to use that area from the right owner.

The displayed contents in the contents section 73 may be a still image or a telop. It is also possible to display a dynamic image.

Further, voice data can be contained in the content data, so that a voice can be reproduced together with the displayed image in the contents section 73.

Note that in the present embodiment, while contents to be transmitted from the information center 51 to the mobile terminal device 61 are normally advertisements, such contents are not limited to the advertisements and other contents such as a trial version of game contents, music contents, and the like may be transmitted as well.

Next, a modified example of the present embodiment will be explained.

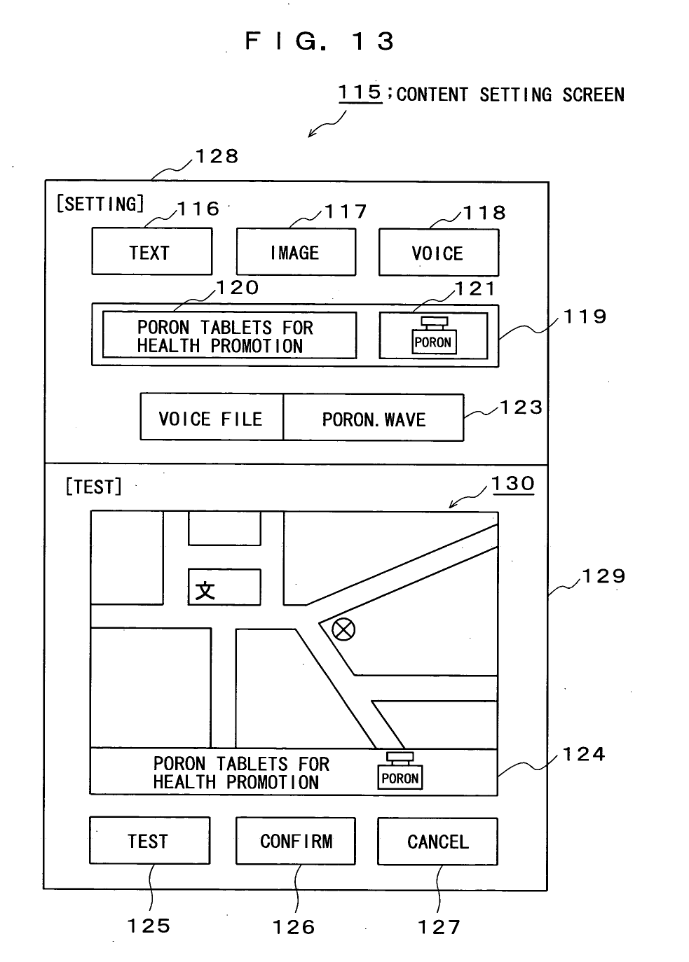

FIG. 13 is a view to explain the modified example of the present embodiment.

The present modified example allows an advertiser to set a time frame when the advertiser purchases an area. This means that the advertiser owns the right to transmit contents to the set area during the set time period. Accordingly, by setting the time frames for the geographically same area, advertisers can be set for each time frame.

FIG. 13(A) shows an area setting screen 140 through which the advertiser sets an area to purchase. The screen image is one which is displayed on the display 20 of the advertiser terminal device 7 by the area setting module 41 of the area sales server 5.

The area setting screen 140 is a screen in which the area setting screen 100 is further provided with a time frame selecting column 141.

In this modified example, the time frame is set for every 6 hours, for instance, from 0 a.m. to 6 a.m., 6 a.m. to 12 a.m., 12 a.m. to 6 p.m., and 6 p.m. to 12 p.m. In the time frame selecting column 141, an option key is provided on the left side of each time period shown. The advertiser can select a time frame by left-clicking the option button with a mouse.

In the example of FIG. 13(A), a time frame from 6 a.m. to 12 a.m. is selected.

In the map screen 142, the areas 143 and 144 already sold for the time frame from 6 a.m. to 12 a.m. are displayed in which they are circled on the map by a dashed line.

For the above time frame, an advertiser may set an area other than the areas 143 and 144 in the region.

FIG. 13(B) shows a case in which the time frame from 6 p.m. to 12 p.m. is selected.

When an advertiser selects the time frame from 6 p.m. to 12 p.m., the areas 145 and 146 already sold for that time frame are displayed in which they are circled by a dashed line.

For that time frame, an advertiser may set an area other than the areas 145 and 146 in the region.

In this modified example, the time frame is specified when an area is set, and time frame data is added to the area information 97 (FIG. 3).

Therewith, the transmission server 78 further includes a time obtaining means to obtain the present time, and when receiving the present positional information from the mobile terminal device 61, specifies the area where the mobile terminal device 61 is located, and the content data to be transmitted to the mobile terminal device 61 from a time frame under which the time of receiving the present position information falls.

Note that while in this modified example an area is set by the time frame, another unit such as season, term, advertisement category or the like may be used to set an area.

When an area is set by season, an advertiser may select a desired season among spring, summer, fall and winter. The range of each season is clearly identified, such as July, August, and September as summer. The advertiser owns the right to transmit information within a certain area during the specified season.

When an area is set by term, an advertiser may specify a desired term, for example, from April 8 to October 12.

When an area is set by advertisement category, such an area is set by a category which is composed of non-competing business sectors such as a restaurant and a realtor. The categories composed of the non-competing businesses should be established in advance.

An area with any of such categories is sold independently from areas with the other categories. When areas with different categories overlap in the same region, the content data corresponding to that overlapping areas are transmitted one by one every minute, for example.

By selling the areas by category as described above, the same region can be sold to multiple advertisers.

Further, while the present embodiment is constituted such that users can set an area range as they like by using a map, an area may be set with other methods.

For example, when content data is transmitted using a cell phone base station, it is possible to structure the setting of an area on the basis of the cell phone station base. In the cell phone system, so as to transmit and receive data through the nearest base station for a moving user, a switch-over between base stations is carried out. Accordingly, as a vehicle travels, the content data related to a nearest base station are transmitted to the vehicle from the nearest base station.

It is also possible to set an area based on road. In that case, an area is set for a certain section of a certain road, for example, a section from the first street of ◯ town to the third street of × town along the National Route ◯Δ.

It is further possible to set an area by the beacon as explained in the present embodiment, when content data is transmitted to a mobile terminal via a beacon. In that case, the exclusive right for transmitting contents such as an advertisement to a mobile terminal from a beacon is sold on a beacon basis. Note that when contents and the like are transmitted to the mobile terminal via a beacon, the present positional information is so obtained that a position where the beacon detects the presence of a vehicle is deemed as the present position of the mobile terminal device.

Further, in the present embodiment, an example is given in which the content data is transmitted to the mobile terminal device installed on the vehicle. However, such a transmission destination is not limited to a vehicle, and the destination may be a mobile terminal device installed on a cell phone or an electric train, for example.

As has been described, in the present embodiment, an area is set in a region to which information such as content data is transmitted, and in order to relate an area to information, a predetermined information can be transmitted limitedly to a specific region.

Further, by taking a structure to sell or buy the right to transmit information within an area, a virtual land on an electronic map can imitatedly be sold to those who want to purchase such a land.

The sales price of an area may reflect the area size by “tsubo” (which is the Japanese area measuring unit, the possessory period, the appraisal value of the land, and the like. It should be noted that the sales price of the area (virtual land) is not necessarily identical to the actual land price.

Furthermore, a density of vehicles of a particular region can be obtained by the transmission server 78 in real time, which can be reflected in the area price.

As the price of an area fluctuates like a stock price according to the density of vehicles, such an area can be a subject of speculation. In other words, an area can be purchased for the purpose of speculation, and sold to obtain a gain when the price thereof increases.

Further, a purchaser of an area (a virtual land owner, specifically an individual, a company, or the like) segmentizes the possessing area by division, so as to use, sell, or lease such a segmentized area.

For example, these areas may be sold like a real estate by a business entity which operates the information center 51, so that anyone who wants to transmit information purchases a desired area from the business entity and obtains the information transmission right in that area. Further, as in the case of a real estate, the purchaser of an area may set a right to use an area for a third party, or sell a part or all of the area to a third party.

Accordingly, the advertisers 52 and 53 may be purchasers of the areas 56 and 57, or those who obtained the right to use from the purchasers of the areas 56 and 57, or the like.

It is also possible to make an area a subject of speculation by treating such an area as a virtual real estate.

In addition, the price of an area may be structured to fluctuate like a stock price according to an increase and a decrease of traffic of vehicles within the area.

The present invention is not intended to be limited to the present embodiments, and various modifications may be made therein within the scope described in the claims.

For example, in the present embodiment the vehicle transmits the positional information to the information center 51 regularly, but a different structure is possible in which the information center downloads the area information and the displaying information into the vehicle in advance, and the content is displayed when the vehicle enters a predetermined area.

Further, the mobile terminal device 61 of the present embodiment may be constituted inexpensively by providing a communication device in a prevalent car navigation device. It is logically possible that the device is composed solely of a GPS device and a communication device.

In the present embodiment, the transmission server 78 and the area sales server 5 are connected by a network, but this is not a limited way, and they may be constituted by one server device. Such a structure is realized if each function of the transmission server 78 is formed by the area sales server 5.

In addition, the area information database 83 (FIG. 2) may be stored in the database 40 (FIG. 4). In that case, the area information updating module 44 updates the area information database 83 stored in the database 40 when receiving the input data from an advertiser via the internet 8.

Further, while the present embodiment refers a case in which only the sales fee of an area is charged to an advertiser who purchased a region, a fee according to the transmission frequency may be charged to an advertiser by counting how many times content data are transmitted by the area sales server 51 to the mobile terminal device 61.

### INDUSTRIAL APPLICABILITY

With the present invention, a device for transmitting information for each region and a method for transmitting information for each region having higher effect in transmitting information for a person who wants to transmit information can be provided.

1. A device for transmitting information for each region comprising:
a region specifying information obtaining means for each region to obtain region specifying information for specifying a region from a region purchaser who wants to purchase the region to which he/she transmits information;
an information-for-transmission obtaining means to obtain information for transmission from said region purchaser who has obtained said region specifying information;
a storing means to store in a storage medium said obtained region specifying information and said obtained information for transmission by relating one to the other;
a present position obtaining means to obtain a present position information to specify a present position of a mobile terminal device;
a region determination means to determine in which of each region stored in said storage medium said obtained present position of said mobile terminal device is located; and
a transmission means to transmit to an applicable mobile terminal device, when the mobile terminal device is determined to be located in any of the regions, said information for transmission related to the region which is stored in the storage medium.

2. An information transmitting device for each region according to claim 1, comprising:
a region fee amount calculating means to calculate a fee amount of a region specified by said obtained region specifying information; and
a region fee outputting means to output said calculated region fee amount.

3. An information transmitting device for each region according to claim 2, wherein said region fee amount calculating means calculates a fee amount of a region based on at least one of an area size of the region, the number of signals present in the region, an availability of parking spaces in the region, a length of roads in the region, a density of mobile terminal device in the region, and a moved distance of a mobile terminal device passing through the region.

4. An information transmitting device for each region according to claim 1, wherein a map transmission means is provided to transmit a map information to display a map which indicates regions available for sale according to a request by a region purchaser, to the region purchaser who made the request, and wherein said region specifying information obtaining means obtains the area specifying information specified by said region purchaser based on said transmitted map information.

5. An information transmitting device for each region according to claim 1, wherein said region specifying information obtaining means sells a non-overlapping region to the region purchaser by obtaining the region specifying information on a region which does not overlap the region specified in the region specifying information already stored in said storage medium.

6. An information transmitting device for each region according to claim 1, wherein said region specifying information obtaining means obtains, together with the region specifying information, an additional condition information to specify an additional condition consisting at least one of a season, a time frame, and a term so that a region in which both the region and the additional condition thereof do not overlap is sold to the region purchaser,
wherein said storing means stores in the storage medium the obtained region specifying information, the obtained information for transmission, and the obtained additional condition information while relating these three information to each other, and
wherein said region determination means determines where the obtained present position of the mobile terminal device is located within any region stored in the storage medium which satisfies the additional condition related to each region.

7. An information transmitting method for each region comprising:
a region specifying information obtaining step in which the region specifying information obtaining means obtains the region specifying information to specify a region from the region purchaser who wants to purchase the region to which he/she transmits information;
an information-for-transmission obtaining step in which the information-for-transmission obtaining means obtains the information for transmission from the region purchaser who has obtained the region specifying information;
a storing step in which the storing means stores in the storage media the obtained region specifying information and the obtained information for transmission while relating one to the other;
a present position information obtaining step in which a present position information obtaining means obtains the present position information to specify the present position of the mobile terminal device;
a region determining step in which the region determination means determines where the obtained present position of the mobile terminal device is located within any of each region stored in the storage medium; and
a transmitting step in which the transmission means transmits to an applicable mobile terminal device, when the mobile terminal device is determined to be located within any of the regions, the information for transmission stored in the storage media which is related to the region.
